(19) United States
(12) Patent Application Publication
(10) Pub. No.: US 2005/0007939 A1
(43) Pub. Date: Jan. 13, 2005

(54) Small-sized optical disc, data recording apparatus, and a method for recording data to the same

(75) Inventors: Ki-hyun Kim, Seongnam-si (KR); Yoon-woo Lee, Suwon-si (KR); Ju-young Park, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/847,676

(22) Filed: May 18, 2004

(30) Foreign Application Priority Data
May 19, 2003 (KR) 2003-31542

(51) Int. Cl. G11B 5/09; G11B 7/24

(52) U.S. Cl. 369/275.3; 369/275.4; 369/59.25

(57) ABSTRACT

An optical disc, a data recording apparatus, and a method of recording data to the optical disc, the optical disc including a first recording area extending from an innermost circumference to a predetermined circumference of the optical disc, and a second recording area extending from the predetermined circumference to an outermost circumference, wherein first recording units, each having a shorter length than a predetermined track of the first recording area, are recorded in the first recording area, and second recording units, each having a longer length than each of the first recording units, are recorded in the second recording area.

### CROSS-REFERENCE TO RELATED APPLICATIONS

This application claims the priority of Korean Patent Application No. 2003-31542, filed on May 19, 2003, in the Korean Intellectual Property Office, the disclosure of which is incorporated herein by reference.

### BACKGROUND OF THE INVENTION

1. Field of the Invention

The present invention relates to a small-sized optical disc, an apparatus to record data to the small-sized optical disc, and a method of recording data to the small-sized optical disc.

2. Description of the Related Art

Different types of information recording media include magnetic discs such as a floppy disc and a hard disc, magnetic tape, semiconductor memory chips such as ROM and RAM, and optical discs such as CDs and DVDs.

Among the information recording mediums, the recording capacity of an optical disc has rapidly increased along with the development of semiconductor techniques and signal processing techniques, and the price of optical discs is relatively low.

Information recorded in an optical disc is recorded as block units with a predetermined size. The block unit in which data is recorded is also a basic unit for error correction code (ECC). A size of the ECC block used in a conventional optical disc is generally 32 KByte or 64 KByte.

Attempts have been made to use the optical disc as an information recording medium for recording and/or reproducing both sound and an image simultaneously with a portable electronic device such as a camcorder.

However, use of the optical disc in such a portable electronic device like a camcorder has a few shortcomings. That is, the widely used size of the optical disc, which is 80 mm or 120 mm, is too big for a camcorder, and power consumption is too high using the conventionally sized disc.

Accordingly, to use an optical disc as an information recording medium for a portable electronic device, an optical disc with a smaller size, but higher recording density, than a conventional optical disc is required.

However, when recording data on a small-sized optical disc with a conventional size ECC block unit, a problem may occur in an inner area of the small-sized optical disc.

FIG. 1 is a schematic drawing illustrating an inner area of a small-sized optical disc in which data is recorded in conventional ECC block units.

Referring to FIG. 1, when a 64 Kbyte ECC block unit is recorded from an inner area to an outer area in the data recording area within a radius of 6 mm from the center of a small-sized optical disc, the ECC block unit is recorded in the area from point A to point B in FIG. 1. That is, when recording a ECC block unit from the innermost area of the small-sized optical disc, it is recorded over almost two tracks. If there is a scratch on an inner area in a radial direction, as shown in FIG. 1, a serious error may occur in the ECC block unit recorded in the innermost area, thus reducing error correction capability remarkably.

That is, when the ECC block unit is not recorded to only one track, but to two tracks of the small-sized optical disc, the error correction capability of the recorded unit ECC block is remarkably reduced if there is any defect on the inner area such as a scratch.

A conventional optical disc has a lead-in area, a user data area, and a lead-out area sequentially formed from an inner radius to an outer radius of the conventional optical disc. Generally important information for reproducing data of the optical disc is recorded in an inner area corresponding to the lead-in area.

Therefore, if there is a defect in the inner area, such as a scratch on the optical disc, error correction capability of the ECC block unit recorded in the inner area is greatly reduced.

### SUMMARY OF THE INVENTION

The present invention provides a small-sized optical disc with a high error correction capability when there is a defect on an inner area on which important information is recorded.

The present invention also provides a data recording apparatus and a method of recording data with a high error correction capability when there is a defect in an inner area of the small-sized optical disc on which important information is recorded.

Additional aspects and/or advantages of the invention will be set forth in part in the description which follows and, in part, will be obvious from the description, or may be learned by practice of the invention.

According to an aspect of the present invention, there is provided an optical disc comprising: a first recording area extending from an innermost circumference to a predetermined circumference of the optical disc; and a second recording area extending from the predetermined circumference to an outermost circumference, wherein first recording units, each having a shorter length than a predetermined track of the first recording area, are recorded in the first recording area, and second recording units, each having a longer length than each of the first recording units, are recorded in the second recording area.

Identical data may be recorded in at least two of the first recording units in the first recording area. Address data indicating addresses of each of the first and second recording units may be recorded on the optical disc, lengths of the address data indicating the address of each of the first recording units may be equal to the length of each of the first recording units, and lengths of the address data indicating the address of each of the second recording units may be equal to the length of each of the second recording units.

The length of each of the second recording units may be an integer multiple of the length of each of the first recording units, the integer being greater than 1.

According to another aspect of the present invention, there is provided a data recording apparatus for an optical disc having a first recording area extending from an innermost circumference to a predetermined circumference of the optical disc, and a second recording area extending from the predetermined circumference to an outermost circumference, the apparatus comprising: an optical head; and a control unit to control the optical head to record data in first recording units, each of the first recording units having a shorter length than a predetermined track of the first recording area, in the first recording area, and to record the data in second recording units, each of the second recording units having a greater length than each of the first recording units, in the second recording area.

The data recording apparatus may further comprise an optical disc information storage unit in which address information of the first recording area and the second recording area are stored, wherein the control unit controls the optical head to record the data in the first recording area and the second recording area, respectively, by referring to the address information stored in the optical disc information storage unit.

The control unit may control the optical head to record identical data in at least two of the first recording units in response to the data being recorded in the first recording area.

According to another aspect of the present invention, there is provided a method of recording data to an optical disc, the method comprising: selecting a data recording area from one of a first recording area extending from an innermost circumference to a predetermined circumference of the optical disc, and a second recording area extending from the predetermined circumference to an outermost circumference; recording the data in first recording units, each of the first recording units having a shorter length than a predetermined track of the first recording area, in response to the data being recorded in the first recording area; and recording the data in second recording units, each of the second recording units having a longer length than the first recording units, in response to the data being recorded in the second recording area.

Identical data may be recorded in at least two of the first recording units in response to the data being recorded in the first recording area.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic drawing of an innermost area of a small-sized optical disc on which conventional unit ECC block data is recorded;

FIG. 2 is a schematic drawing of a small-sized optical disc according to an embodiment of the present invention;

FIG. 3 is a schematic drawing showing a first recording unit and a second recording unit;

FIG. 4 shows disc tracks formed according to a wobble signal that indicates an address signal;

FIGS. 5A and 5B show address data corresponding to each of a first recording unit and a second recording unit;

FIG. 6 is a block diagram of a data recording apparatus according to an embodiment of the present invention;

FIG. 7 shows an example of an optical disc information table in which information regarding the small-sized optical disc is recorded; and

FIG. 8 is a block diagram illustrating a method of recording data according to an embodiment of the present invention.

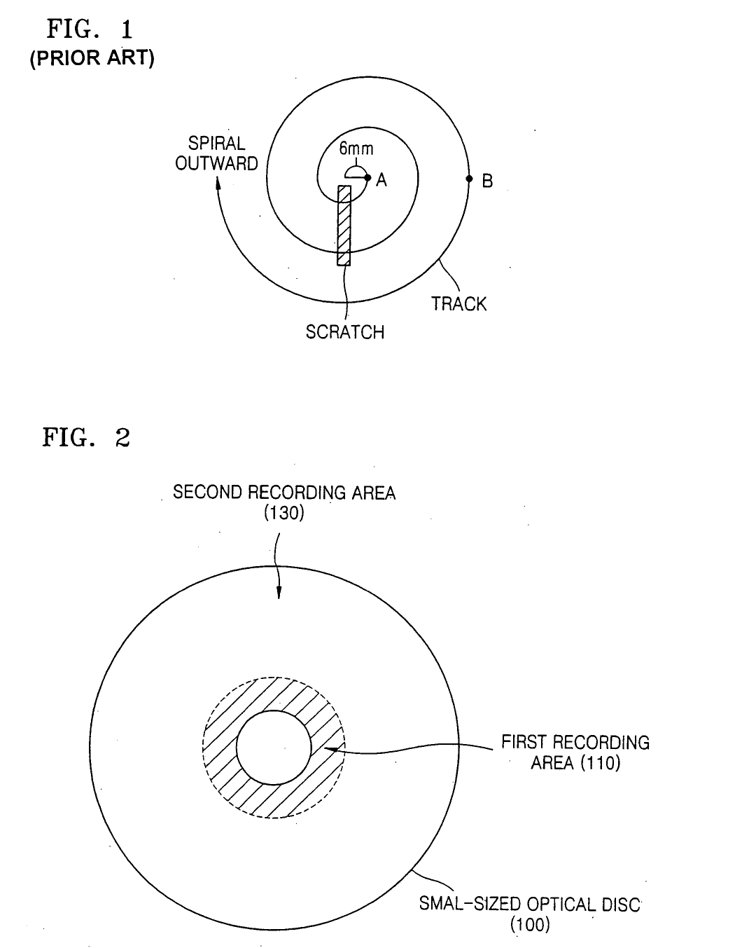

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 2 is a schematic drawing of a small-sized optical disc according to an embodiment of the present invention.

Referring to FIG. 2, a small-sized optical disc 100 includes a first recording area 110 and a second recording area 130.

The first recording area 110 extends from an innermost circumference at which data can be recorded to a predetermined circumference. In the first recording area 110, data is recorded in first recording units.

The second recording area 130 extends from the predetermined circumference to an outermost circumference at which data can be recorded. In the second recording area 130, data is recorded in second recording units.

The first recording unit and the second recording unit respectively correspond to the ECC block of the first recording area 110 and the second recording area 130.

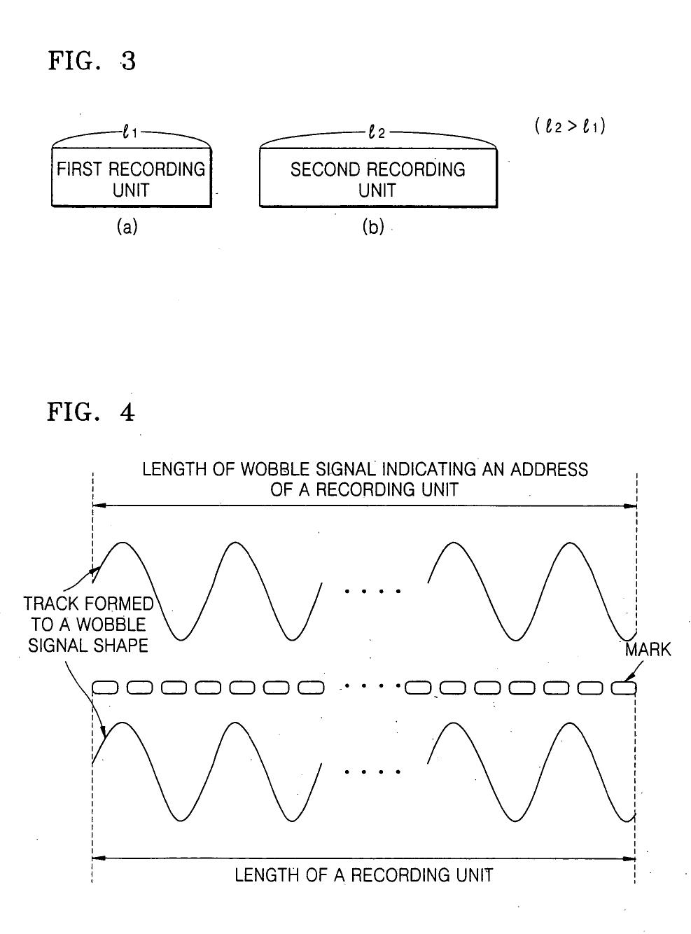

FIG. 3 is a schematic drawing showing a first recording unit and a second recording unit. Referring to FIG. 3, the first recording unit has a length l₁, and the second recording unit has a length l₂.

The length l₁ of the first recording unit is less than the length l₂ of the second recording unit, and less than a length of a predetermined track of the first recording area 110 of the small-sized optical disc 100. Hereinafter, it is assumed that the length l₁ of the first recording unit is less than the length of the innermost track of the small-sized optical disc.

That is, as described above, if there is any defect in the innermost area of the small-sized optical disc, the error correction capability of the ECC block recorded on the innermost area is remarkably reduced. To alleviate this problem, the first recording unit data, the first recording unit being shorter than the innermost track, is recorded to the inner area, i.e., the first recording area 110 of the small-sized optical disc 100, and the second recording unit data is recorded to the second recording area 130.

The length of the second recording unit is greater than that of the first recording unit because the larger the ECC block unit, i.e., the record unit, the greater the error correction capability. The size of the ECC block indicates the amount of data recorded in the ECC block. As the size of the ECC block increases, a physical length of the ECC block recorded to the optical disc increases.

Therefore, the first recording unit data, the first recording unit being shorter than the innermost track of the small-sized optical disc 100, is recorded to the first recording area 110, even though the error correction capability is reduced. And the second recording unit data, the second recording unit being longer than the first recording unit, is recorded to the second recording area 130.

When data is recorded from an inner area to an outer area of the small-sized optical disc 100, data to be recorded to a lead-in area of the small-sized optical disc 100 will be recorded to the first recording area 110, which corresponds to the inner area. Generally, the data recorded to the lead-in area of the small-sized optical disc 100 is important data for using the optical disc. Therefore, for reliability of this data, identical data may be recorded in at least two first recording units when recorded to the first recording area 110.

When data is recorded to a small-sized optical disc 100 with multiple recording units having different lengths from each other, a method of recording address data that indicates an address of each recording unit on the small-sized optical disc should be considered.

FIG. 4 shows disc tracks formed according to a wobble signal that indicates an address signal.

One method of recording address data that indicates an address of a recording unit is a method of recording the addressing information by forming the track of the optical disc with a shape equivalent to a wobble signal, after producing the wobble signal by wobble modulating the address information. A few methods of wobble modulation are Monotone Wobble (MW), Saw Tooth Wobble (STW), Binary Phase Shift Keying (BPSK), and Frequency Shift Keying (FSK). The wobble modulation method is widely used to record address information of the optical disc since it is of advantage, for example, to control a speed of a motor which rotates the optical disc.

Referring to FIG. 4, a track is formed with a shape similar to the shape of the wobble produced according to the MW method that modulates the address information into a sign wave with a single frequency. At the center of the track, a mark corresponding to the recorded data is formed.

A wobble signal that indicates an address of a record unit formed on the track has a length equivalent to a recording unit.

However, in the small-sized optical disc 100 according to an embodiment of the present invention, data is recorded with a plurality of recording units having different lengths. Therefore, the address data is recorded by adjusting the length of the first recording unit in consideration of a complexity of a system and an efficiency of data processing.

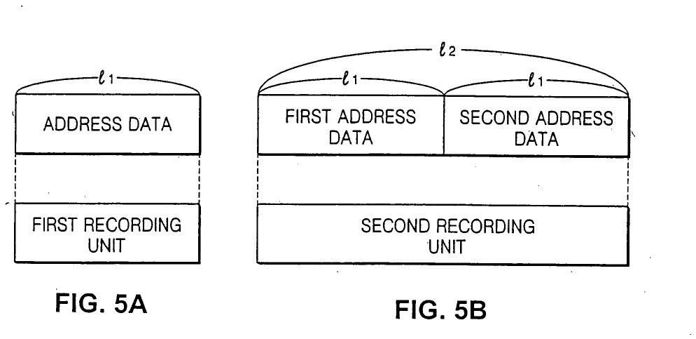

FIGS. 5A and 5B show address data corresponding to each of the first recording unit and the second recording unit. Referring to FIG. 5A, address data corresponding to the first recording unit is recorded with the length l₁ of the first recording unit. Referring to FIG. 5B, address data corresponding to the second recording unit is recorded with the length l₂ by combining first and second address data each having the data length of l₁. This is a case in which the length l₂ of the second recording unit and the address data corresponding to the second recording unit is equal to two times the length l₁ of the first recording unit.

The first address data and the second address data depicted in FIG. 5B together indicate an address of one second recording unit. There are several methods of recording the first address data and the second address data by dividing an address that indicates an address of one second recording unit. For example, data that indicates one address can be recorded as first address data and second address data, repeatedly. Alternately, address data modulated according to a predetermined method can be divided into two parts, and the first half recorded as the first address data and the second half recorded as the second address data.

A data recording apparatus for a small-sized optical disc according to an embodiment of the present invention will now be described.

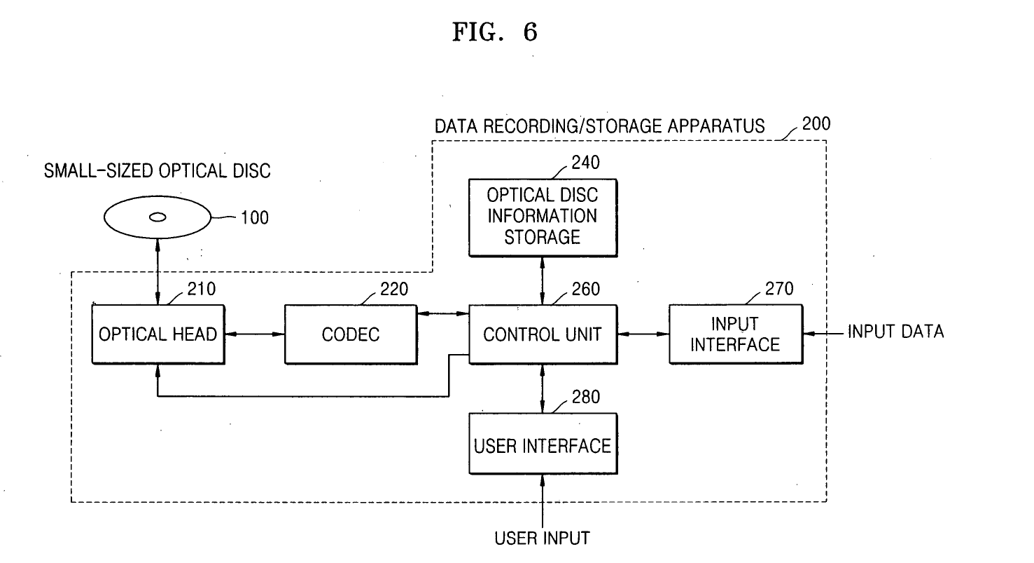

FIG. 6 is a block diagram of a data recording apparatus 200 according to an embodiment of the present invention.

Referring to FIG. 6, the data recording apparatus 200 comprises an optical head 210, a codec 220, an optical disc information storage unit 240, a control unit 260, an input data interface unit 270, and a user interface unit 280.

The optical head 210 records data on the small-sized optical disc 100, or reads data from the small-sized optical disc 100, in response to the control of the control unit 260.

The codec 220 encodes or modulates data to be recorded to the small-sized optical disc 100, or decodes or demodulates data read from the small-sized optical disc 100.

Information regarding the small-sized optical disc 100 is stored in the optical disc information storage unit 240.

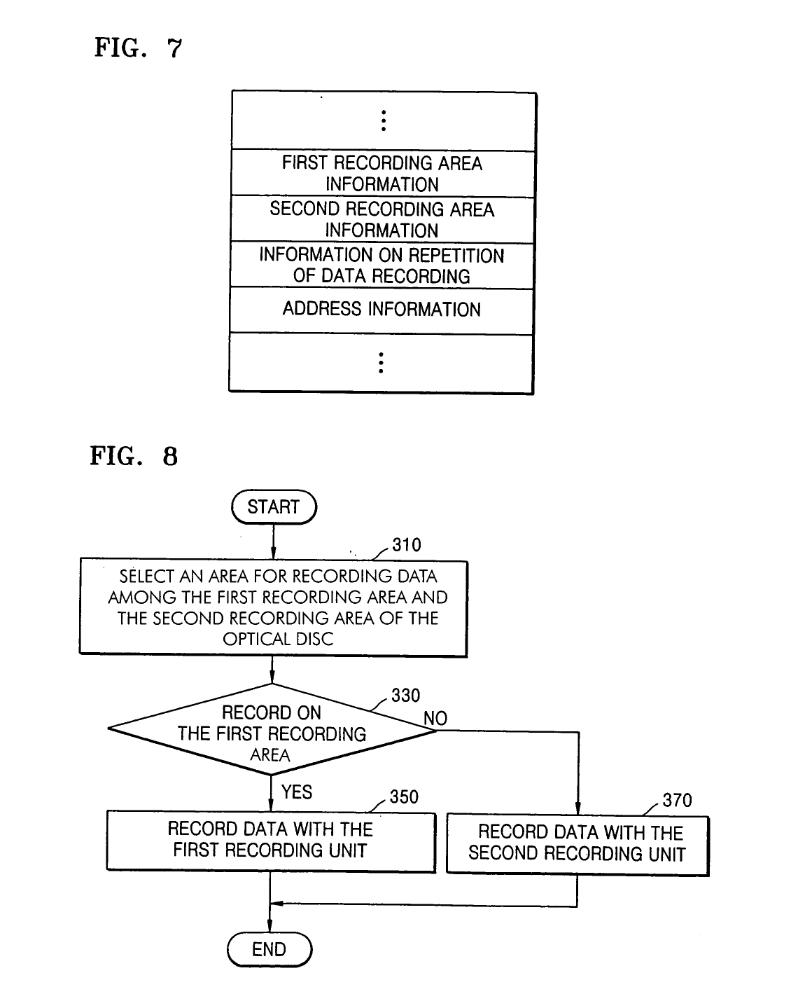

FIG. 7 shows an example of an optical disc information table stored in the optical disc information storage unit 240, in which information regarding the small-sized optical disc is stored. First recording area information, second recording area information, information on repetition of data recording, and address information are recorded in the optical disc information table depicted in FIG. 7.

The first recording area information includes address information of the first recording units to be recorded to the first recording area 110, and the second recording area information includes address information of the second recording units to be recorded to the second recording area.

The information on repetition of data recording includes address information of at least two of the first recording units in which the same data is recorded, in order to record the same data repeatedly in the first recording area 110.

The address information includes information indicating in what way the address data corresponding to the first recording unit and the address data corresponding to the second recording unit are recorded, or how the data is processed to obtain the address data.

The control unit 260 controls the optical head 210 to record data with the first recording unit to the first recording area 110, and to record data with the second recording unit to the second recording area 130, by referring to the address information of the first recording area 110 and the address information of the second recording area 130 recorded in the optical disc information table of the optical disc information storage unit 240.

The control unit 260 also controls the optical head 210 to record identical data in at least two of the first recording units when data is recorded in the first recording area 110.

The input data interface unit 270 transmits inputted data to be recorded to the small-sized optical disc 100 to the control unit 260.

The user interface unit 280 transmits data recording orders received from a user to the control unit 260.

The data recording apparatus 200 according to an embodiment of the present invention can also be used as an apparatus for reproducing data recorded to the small-sized optical disc.

With reference to the data recording apparatus 200 described above, a method of recording data to the small-sized optical disc 100 according to an embodiment of the present invention will be described.

FIG. 8 is a flow chart illustrating a method of recording data according to an embodiment of the present invention.

Referring to FIG. 8, the control unit 260 determines one of the first recording area 110 and second recording area 130 of the small-sized optical disc 100 for data recording after receiving a command to record data, and data to be recorded, from a user (operation 310).

It is thus determined whether the first recording area 110 is selected (operation 330).

If the first recording area 110 is selected, the optical head 210 records data with the first recording unit, which is shorter than the innermost circumference of the small-sized optical disc 100, in response to the control of the control unit 260 (operation 350).

On the other hand, if the second recording area 130 is selected, the optical head 210 records data with the second recording unit, which has a greater length than the first recording unit, in response to the control of the control unit 260 (operation 370).

When data is recorded to the first recording area 110 during operation 350, the control unit 260 controls the optical head 210 to record the same data with at least two first recording units.

The present invention can also be embodied as computer readable code on a computer readable recording medium. The computer readable recoding medium is any data storage device that can store data which can be thereafter read by a computer system. Examples of the computer readable recording medium include read-only memory (ROM), random access memory (RAM), CD-ROMs, magnetic tapes, floppy discs, optical data storage devices, and carrier waves. The computer readable recording medium can also be distributed over network coupled computer systems so that the computer readable code is stored and executed in a distributed fashion.

As described above, according to an embodiment of the present invention, a small-sized optical disc can provide an error correction capability of data recorded to an inner area of the optical disc by recording the same data twice, with recording units each having a shorter length than the length of an innermost track.

Also, an apparatus to record data on an optical disc, and a method of recording data on an optical disc, improve error correction capability when reproducing data recorded to the small-sized optical disc by recording data with recording units each having a shorter length than the length of an innermost track, and recording the same data at least twice.

Although a few embodiments of the present invention have been shown and described, it would be appreciated by those skilled in the art that changes may be made in these embodiments without departing from the principles and spirit of the invention, the scope of which is defined in the claims and their equivalents.

1. An optical disc comprising:
a first recording area extending from an innermost circumference to a predetermined circumference of the optical disc; and
a second recording area extending from the predetermined circumference to an outermost circumference;
wherein first recording units, each having a shorter length than a predetermined track of the first recording area, are recorded in the first recording area, and second recording units, each having a longer length than each of the first recording units, are recorded in the second recording area.

2. The optical disc of claim 1, wherein identical data is recorded in at least two of the first recording units in the first recording area.

3. The optical disc of claim 1, wherein address data indicating addresses of each of the first and second recording units is recorded on the optical disc, lengths of the address data indicating the address of each of the first recording units are equal to the length of each of the first recording units, and lengths of the address data indicating the address of each of the second recording units are equal to the length of each of the second recording units.

4. The optical disc of claim 3, wherein the length of each of the second recording units is an integer multiple of the length of each of the first recording units, and the integer is greater than 1.

5. The optical disc of claim 3, wherein the address data indicating the addresses of each of the second recording units is recorded as first address data and second address data, the first address data and the second address data each having the length of each of the first recording units.

6. The optical disc of claim 1, wherein the predetermined track of the first recording area is an innermost track of the optical disc.

7. The optical disc of claim 1, wherein the predetermined track of the optical disc is formed according to a shape of a wobble signal.

8. The optical disc of claim 7, wherein the wobble signal is produced by wobble modulating address information for the first and second recording units.

9. The optical disc of claim 8, wherein the wobble modulation is one of Monotone Wobble (MW), Saw Tooth Wobble (STW), Binary Phase Shift Keying (BPSK), and Frequency Shift Keying (FSK).

10. The optical disc of claim 7, wherein the wobble signal indicates an address of one of the first or second recording units, and the wobble signal has a length equal to the one of the first or second recording units.

11. A data recording apparatus for an optical disc having a first recording area extending from an innermost circumference to a predetermined circumference of the optical disc, and a second recording area extending from the predetermined circumference to an outermost circumference, the apparatus comprising:
an optical head; and
a control unit to control the optical head to record data in first recording units, each of the first recording units having a shorter length than a predetermined track of the first recording area, in the first recording area, and to record the data in second recording units, each of the second recording units having a greater length than each of the first recording units, in the second recording area.

12. The data recording apparatus of claim 11, further comprising an optical disc information storage unit in which address information of the first recording area and the second recording area are stored, wherein the control unit controls the optical head to record the data in the first recording area and the second recording area, respectively, by referring to the address information stored in the optical disc information storage unit.

13. The data recording apparatus of claim 11, wherein the control unit controls the optical head to record identical data in at least two of the first recording units in response to the data being recorded in the first recording area.

14. A method of recording data to an optical disc, the method comprising:
selecting a data recording area from one of a first recording area extending from an innermost circumference to a predetermined circumference of the optical disc, and a second recording area extending from the predetermined circumference to an outermost circumference;
recording the data in first recording units, each of the first recording units having a shorter length than a predetermined track of the first recording area, in response to the data being recorded in the first recording area; and
recording the data in second recording units, each of the second recording units having a longer length than the first recording units, in response to the data being recorded in the second recording area.

15. The method of claim 14, wherein identical data is recorded in at least two of the first recording units in response to the data being recorded in the first recording area.

16. A recording medium on which a method of recording data to an optical disc is recorded, the method comprising:
selecting a data recording area from one of a first recording area extending from an innermost circumference to a predetermined circumference of the optical disc, and a second recording area extending from the predetermined circumference to an outermost circumference;
recording the data in first recording units, each of the first recording units having a shorter length than a predetermined track of the first recording area, in response to the data being recorded in the first recording area; and
recording the data in second recording units, each of the second recording units having a longer length than the first recording units, in response to the data being recorded in the second recording area.

17. An optical disc comprising a plurality of recording areas, wherein recording units in an inner recording area are shorter than a predetermined track of the inner recording area, and recording units in an outer recording area are longer than the recording units in the inner recording area.

18. The optical disc of claim 17, wherein identical data is recorded in at least two of the recording units in the inner recording area.

19. An optical disc in which data is recorded in an inner recording area in recording units that are shorter than, or equal to, an innermost track of the optical disc.

20. The optical disc of claim 19, wherein identical data is recorded in at least two of the recording units in the inner recording area.
